(19) United States
(12) Patent Application Publication
(10) Pub. No.: US 2008/0062702 A1
(43) Pub. Date: Mar. 13, 2008

(54) APPARATUS AND METHOD AS WELL AS EQUIPMENT FOR TESTING IMAGE SENSORS

(75) Inventors: Hui Hsuan CHEN, Science-Based Industrial Park Hsin-Chu (TW); Jing Jung Pan, Science-Based Industrial Park Hsin-Chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., HSIN-CHU COUNTY (TW)

(21) Appl. No.: 11/839,302

(22) Filed: Aug. 15, 2007

(30) Foreign Application Priority Data
Sep. 8, 2006 (TW) 095133175

(51) Int. Cl. F21V 5/00

(52) U.S. Cl. 362/311

(57) ABSTRACT

An apparatus for testing image sensors is provided. The light beam emanating from a light source is transformed into a diffused light beam by a beam diffuser and then cast on the sensing area of a tested image sensor. In this manner, although the test light beam coming from a certain direction is obstructed by the spots on the transparent cover and therefore fails to reach one point on the sensing area, the test light beam coming from other direction can still reach that point. Accordingly, the shadows of the spots on the sensing area are not clear; the accuracy of testing the image sensor can be greatly improved.

### CROSS REFERENCE TO RELATED APPLICATION

This application claims the priority benefit of Taiwan Patent Application Ser. Number 095133175 filed Sep. 8, 2006, the full disclosure of which is incorporated herein by reference.

### BACKGROUND OF THE INVENTION

1. Field of the Invention

The invention relates to an apparatus, method and equipment for testing image sensors, and more particularly, to an apparatus, method and equipment for testing image sensors with a diffused light beam.

2. Description of the Related Art

Referring to FIG. 1, a conventional image sensor 100 includes a substrate 110 with an upper surface 112 and a lower surface 114. A sensing area 120 is defined on the upper surface 112 of the substrate 110 and can sense an image light beam 130. A plurality of bumps 140 is attached to the lower surface 114 of the substrate 110 and adapted to transmit an image signal generated by the sensing area 120 in response to the image light beam 130 to an external apparatus. In order to protect the sensing area 120 from contamination, a transparent cover 150 is commonly used to cover the sensing area 120.

Referring to FIG. 2, in order to test the performance of the image sensor 100, a collimated light beam 230 is commonly used to test the image sensor 100. The collimated light beam 230 will pass through the transparent cover 150 and reach the sensing area 120. When there exists a spot 260 such as dust or water stain on the transparent cover 150, the spot 260 will obstruct a portion of the collimated light beam 230 and therefore cast a shadow on the sensing area 120. Such a shadow may cause an inaccurate measurement. To solve this problem, referring to FIGS. 3a and 3b, a lens module 270 is used to transform the collimated light beam 230 into a converging light beam 230a or a diverging light beam 230b. The light beam 230a or 230b will be obliquely incident upon the transparent cover 150 and sensing area 120 and therefore can reduce the shadow of the spot 260 on the sensing area 120.

However, no matter with the converging light beam 230a or diverging light beam 230b, the light beam arriving at each point on the sensing area 120 comes only from a specific direction. When the light beam of the specific direction is obstructed by the spot 260, the spot 260 will still cast a shadow on the sensing area 120. There still exists a possibility of inaccurate measurement.

Accordingly, there exists a need to provide an apparatus and method for testing image sensors to solve the above-mentioned problems.

### SUMMARY OF THE INVENTION

It is an object of the present invention to provide an apparatus for testing image sensors that can produce a diffused light beam to test the image sensor. The diffused light beam can prevent the spot on the transparent cover from casting a shadow on the sensing area of the image sensor thereby avoiding an inaccurate measurement.

In one embodiment, the apparatus for testing image sensors according to the present invention includes a light source and a beam diffuser. The beam diffuser is adapted to transform a light beam emanating from the light source into a diffused light beam and then cast the diffused light beam on the sensing area of a tested image sensor.

It is another object of the present invention to provide equipment for testing image sensors. The equipment includes the above apparatus for testing image sensors and a test machine. The test machine is adapted to electrically connect to the tested image sensor and receive an image signal generated by the sensing area in response to the diffused light beam.

It is further object of the present invention to provide a method for testing image sensors.

Since the diffused light beam transformed by the beam diffuser is cast on the image sensor in various directions, the diffused light beam arriving at each point on the sensing area comes from various directions. When the diffused light beam coming from a certain direction is obstructed by the spot on the transparent cover and therefore fails to reach one point on the sensing area, the diffused light beam coming from other directions can still reach that point. Accordingly, the shadow of the spot on the sensing area is not clear; the accuracy of testing the image sensor can be greatly improved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional image sensor.

FIG. 2 illustrates the image sensor of FIG. 1, wherein a spot is attached to the transparent cover.

FIG. 3a illustrates an apparatus for testing the image sensor of FIG. 1, wherein the test light beam cast on the sensing area of the image sensor is a converging light beam.

FIG. 3b illustrates an apparatus for testing the image sensor of FIG. 1, wherein the test light beam cast on the sensing area of the image sensor is a diverging light beam.

FIG. 4 is a schematic view of the equipment for testing image sensors according to the present invention.

FIG. 5a illustrates the beam diffuser of the present invention, wherein the beam diffuser is a prism plate.

FIG. 5b illustrates the beam diffuser of the present invention, wherein the beam diffuser is a Fresnel lens.

FIG. 5c illustrates the beam diffuser of the present invention, wherein the beam diffuser is a binary grating.

FIG. 6a illustrates that the beam diffuser of the present invention is used with a uniform diffusing plate to produce a diffused light beam.

FIG. 6b illustrates that the beam diffuser of the present invention is used with a polarizer to produce a polarized diffused light beam, wherein the polarizer is positioned upstream of the beam diffuser.

FIG. 6c illustrates that the beam diffuser of the present invention is used with a polarizer to produce a polarized diffused light beam, wherein the polarizer is positioned downstream of the beam diffuser.

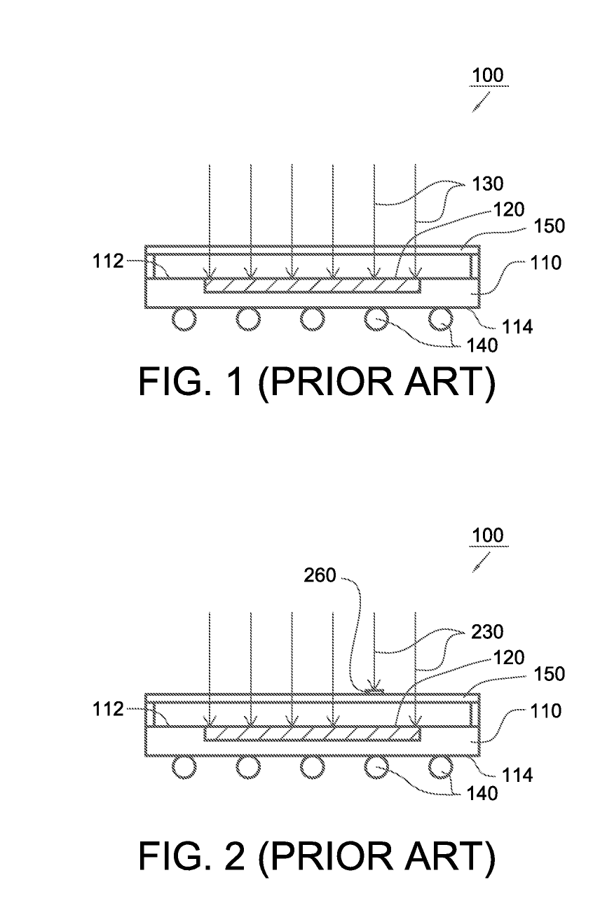

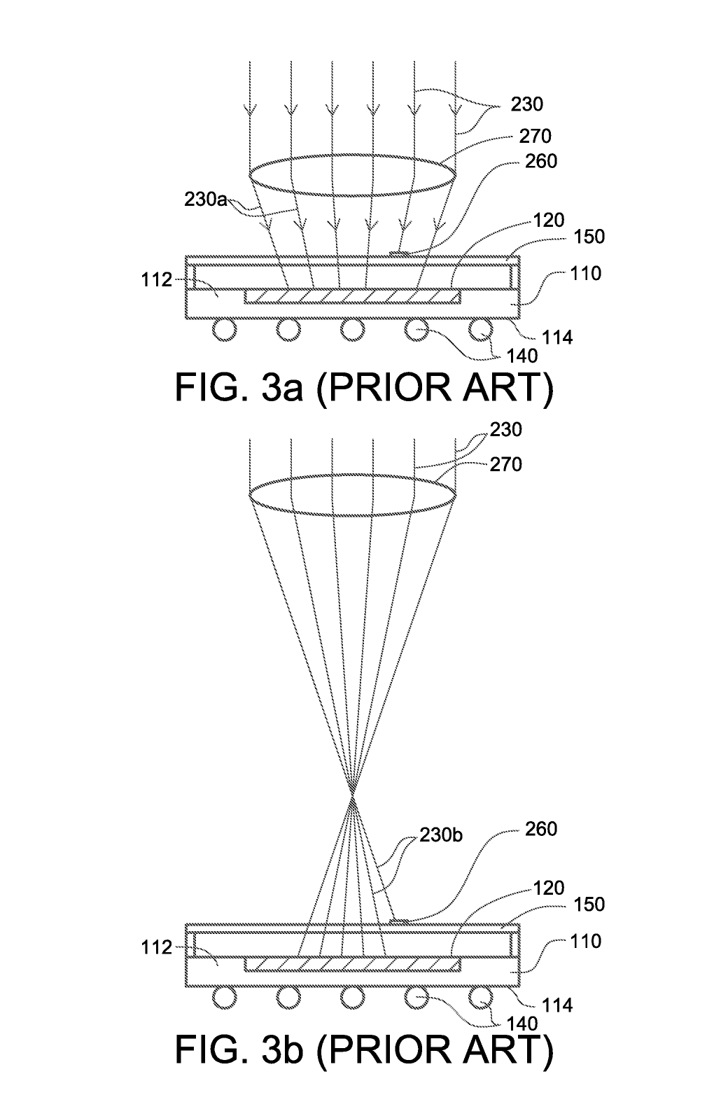

### DETAILED DESCRIPTION OF THE PREFERRED EMBODIMENT

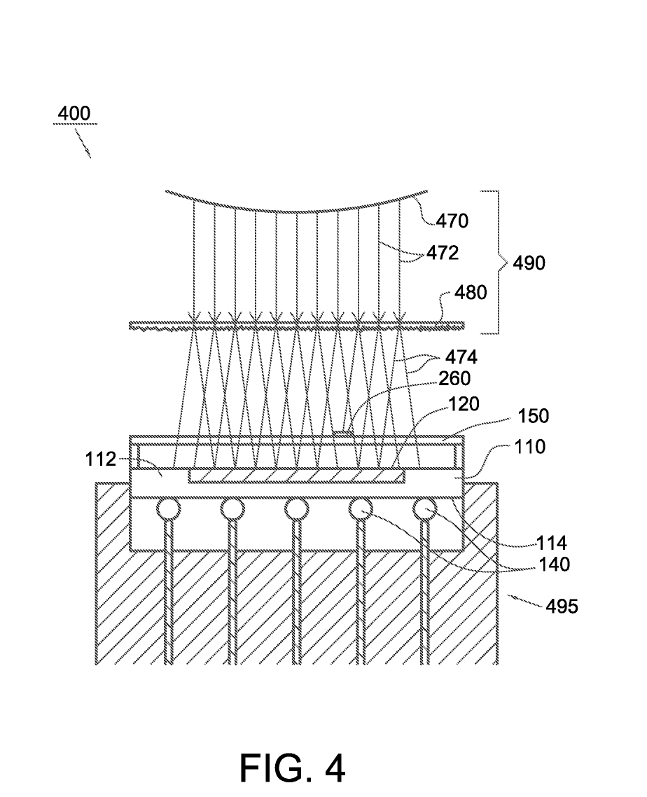

Referring to FIG. 4, equipment 400 for testing image sensors according to the present invention includes an image sensing apparatus 490 having a light source 470 and a beam diffuser 480 adapted to transform a light beam 472 emanating from the light source 470 into a diffused light beam 474.

When the diffused light beam 474 is used to test the performance of the image sensor 100, the bumps 140 of the image sensor 100 are first electrically connected to a test machine 495. The diffused light beam 474 is then cast on the sensing area 120 so that an image signal generated by the sensing area 120 in response to the diffused light beam 474 is transmitted to the test machine 495 via the bumps 140.

The diffused light beam 474 transformed by the beam diffuser 480 is to serve as a test light beam and is cast on the image sensor 100 in various directions. Therefore, the diffused light beam 474 arriving at each point on the sensing area 120 comes from various directions. When the diffused light beam 474 coming from a certain direction is obstructed by the spot 260 and therefore fails to reach one point on the sensing area 120, the diffused light beam 474 coming from other directions can still reach that point. Accordingly, the shadow of the spot 260 on the sensing area 120 is not clear; the accuracy of testing the image sensor 100 can be greatly improved.

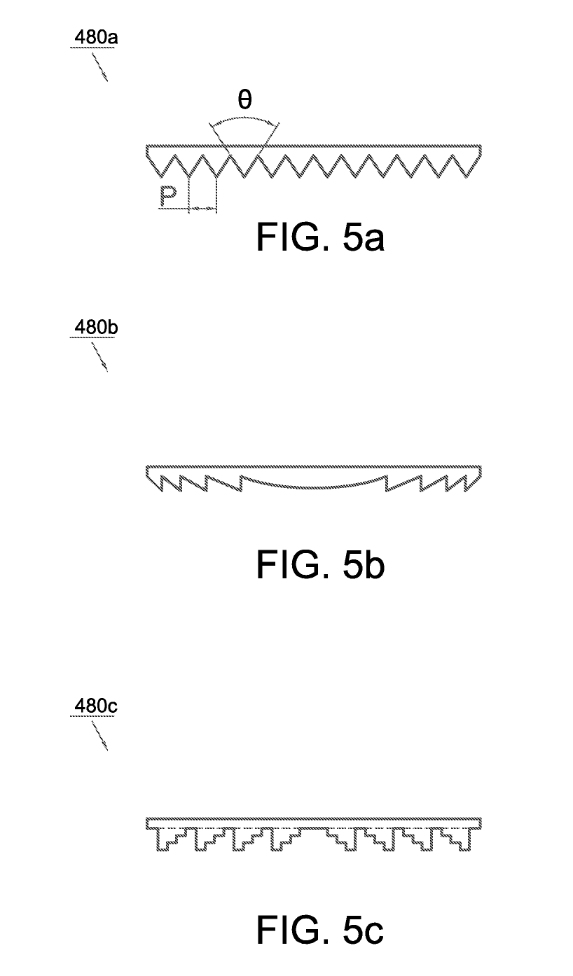

Referring to FIGS. 5a, 5b and 5c, the beam diffuser 480 of the present invention can be composed of a plurality of regularly repeating units or a plurality of alternately repeating units, and be such as prism plate 480a, Fresnel lens 480b or binary grating 480c. When the beam diffuser 480 is the prism plate 480a, the vertex angle θ of the prism plate 480a is between about 5 degrees and about 175 degrees, and the pitch P of the prism plate 480a is between about 15 μm and 100 μm.

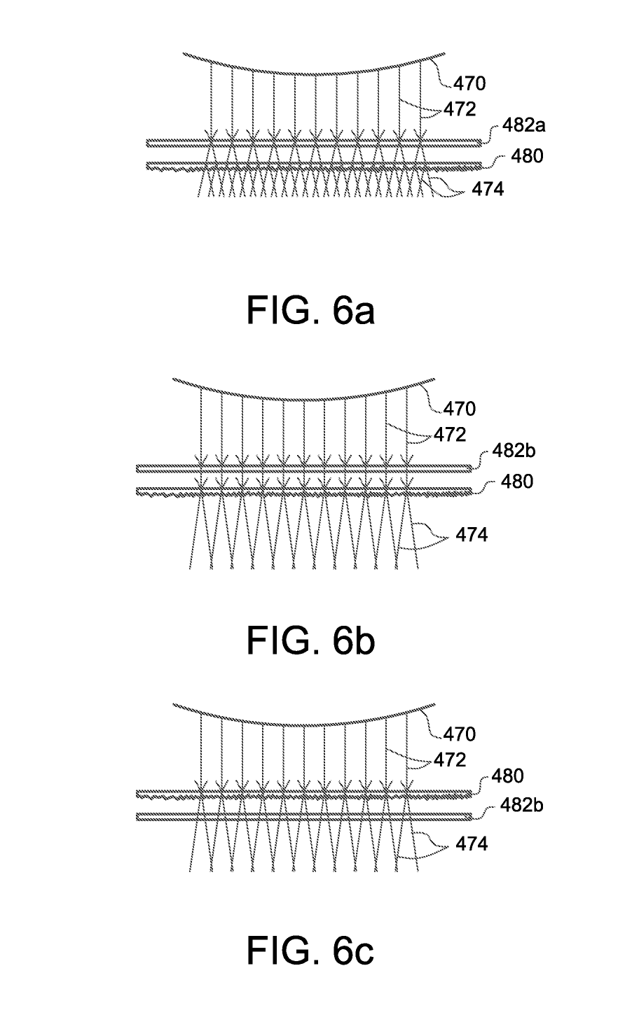

Furthermore, referring to FIGS. 6a, 6b and 6c, the beam diffuser 480 can be used with a uniform diffusing plate 482a or a polarizer 482b to constitute a plurality of regularly repeating units or a plurality of alternately repeating units. When the beam diffuser 480 is used with the uniform diffusing plate 482a, the uniform diffusing plate 482a is optically disposed between the light source 470 and the beam diffuser 480 so that the uniform diffusing plate 482a can diffuse the light beam 472 emanating from the light source 470 in advance and then the beam diffuser 480 further diffuse the light beam emanating from the uniform diffusing plate 482a to obtain the more diffused light beam 474. When the beam diffuser 480 is used with the polarizer 482b, the polarizer 482b can be positioned upstream or downstream of the beam diffuser 480 so that the beam diffuser 480 and polarizer 482b together can transform the light beam 472 into a p-state or s-state diffused light beam 474. To avoid the impact of the spot 260 on the measurement, the polarized diffused light beam 474 can be used to test the LCOS chips or the sensors for color calibration positioned in liquid crystal displays.

Since the diffused light beam 474 transformed by the beam diffuser 480 of the image sensing apparatus 490 is cast on the image sensor 100 in various directions, the diffused light beam 474 arriving at each point on the sensing area 120 comes from various directions. When the diffused light beam 474 coming from a certain direction is obstructed by the spot 260 and therefore fails to reach one point on the sensing area 120, the diffused light beam 474 coming from other directions can still reach that point. Accordingly, the shadow of the spot 260 on the sensing area 120 is not clear; the accuracy of testing the image sensor 100 can be greatly improved. In addition, when a broad beam diffuser 480 and an appropriate light source 470 are employed together to produce a broad diffused light beam 474, more than one image sensor 100 can be tested at a time thereby increasing the test efficiency.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for testing a image sensor, the image sensor having a sensing area to sense a light beam, the apparatus comprising:
a light source adapted to generate a light beam; and
a beam diffuser adapted to transform the light beam emanating from the light source into a diffused light beam and to cast the diffused light beam on the sensing area of the image sensor.

2. The apparatus as claimed in claim 1, wherein the beam diffuser is selected from the group consisting of prism plate, Fresnel lens and binary grating.

3. The apparatus as claimed in claim 2, further comprising:
a polarizer positioned upstream or downstream of the beam diffuser.

4. The apparatus as claimed in claim 2, wherein the beam diffuser is a prism plate, the vertex angle of the prism plate is between about 5 degrees and about 175 degrees, the pitch of the prism plate is between about 15 μm and about 100 μm.

5. A method for testing a image sensor, the image sensor having a sensing area to sense a light beam, the method comprising the steps of:
providing a light source, the light source adapted to generate a light beam; and
providing a beam diffuser in such a manner that the beam diffuser is adapted to transform the light beam emanating from the light source into a diffused light beam and to cast the diffused light beam on the sensing area of the image sensor.

6. The method as claimed in claim 5, wherein the beam diffuser is selected from the group consisting of prism plate, Fresnel lens and binary grating.

7. The method as claimed in claim 6, further comprising:
positioning a polarizer upstream or downstream of the beam diffuser.

8. The method as claimed in claim 6, wherein the beam diffuser is a prism plate, the vertex angle of the prism plate is between about 5 degrees and about 175 degrees, the pitch of the prism plate is between about 15 μm and about 100 μm.

9. An equipment for testing a image sensor, the image sensor having a sensing area to sense a light beam, the equipment comprising:
a test machine adapted to electrically connect to the image sensor;
a light source adapted to generate a light beam; and
a beam diffuser adapted to transform the light beam emanating from the light source into a diffused light beam and to cast the diffused light beam on the sensing area of the image sensor.

10. The equipment as claimed in claim 9, wherein the beam diffuser is selected from the group consisting of prism plate, Fresnel lens and binary grating.

11. The equipment as claimed in claim 10, further comprising:
a polarizer positioned upstream or downstream of the beam diffuser.

12. The equipment as claimed in claim 10, wherein the beam diffuser is a prism plate, the vertex angle of the prism plate is between about 5 degrees and about 175 degrees, the pitch of the prism plate is between about 15 μm and about 100 μm.
